(19) United States
(12) Patent Application Publication
(10) Pub. No.: US 2025/0124132 A1
(43) Pub. Date: Apr. 17, 2025

(54) RUNTIME MEASUREMENT REGISTER-BASED VIRTUAL TRUSTED PLATFORM MODULE

(71) Applicants: Bin XING, Hillsboro, OR (US); Daniel MIDDLETON, Orono, MN (US)

(72) Inventors: Bin XING, Hillsboro, OR (US); Daniel MIDDLETON, Orono, MN (US)

(21) Appl. No.: 18/619,211

(22) Filed: Mar. 28, 2024

Related U.S. Application Data
(60) Provisional application No. 63/589,361, filed on Oct. 11, 2023.

(51) Int. Cl. G06F 21/57

(52) U.S. Cl. CPC G06F 21/57; G06F 2221/033

(57) ABSTRACT

A method and system for implementing a virtual trusted platform module (vTPM). Software components are sequentially loaded and measured from a core root of trust for measurement (CRTM) in a user confidential virtual machine (CVM). The measurements of the software components are recorded in a runtime measurement register (RTMR) log and a digest of each entry of the RTMR log is extended into an RTMR configured for the user CVM. A signed quote and corresponding measurement entries of the RTMR log are provided to a verifier. The signed quote includes a value of the RTMR. A state of the user CVM may be verified based on the RTMR value and the RTMR log entries. The measurement entries of the RTMR log may be replayed to calculate platform configuration register (PCR) values and the TCG event log may be verified using the PCR values.

### BACKGROUND

Trusted Platform Modules (TPMs) cannot be securely simulated for virtual machines without a Trusted Execution Environment (TEE). In the context of Confidential Computing (CC), attestation is about proving the trustworthiness of the TEE and the software programs/components running in it. Attestation is essential to Confidential Computing because any data owner must be assured that its (confidential) data will be handled properly before releasing/provisioning them to a TEE.

There are a variety of TEE technologies existing today, including Intel® Software Guard Extensions and Intel® Trust Domain Extensions (SGX/TDX) and AMD® Secure Encrypted Virtualization (SEV), among others. Each TEE technology provides distinct instruction set architecture (ISA) to attest to the TEE hardware itself, along with the identity and configuration of the software running in it. The diversity in ISA has added cost to software development/deployment and the cloud service providers (CSPs) have been seeking common software abstractions to hide TEE details.

TPM is an industry standard developed before the Confidential Computing era and has wide adoption. Its host interface can be viewed as a generic interface between a host system and a measurement/attestation agent. Therefore, using the TPM interface can not only abstract away ISA differences but also make it easier to port existing use cases to TEEs. Where a physical TPM is used to measure the boot of physical machine, a virtual TPM (vTPM) is used with a virtual machine (VM). As a software construct the vTPM lacks the security properties of a physical TPM. In Confidential Computing, vTPMs are increasingly used with Confidential VMs (CVMs) whether or not the vTPM itself is protected by Confidential Computing.

### BRIEF DESCRIPTION OF THE FIGURES

Some examples of apparatuses and/or methods will be described in the following by way of example only, and with reference to the accompanying figures, in which

FIG. 1 shows a virtual Trusted Platform Module (vTPM) flow;

FIG. 2 shows a RunTime Measurement Register (RTMR)-based vTPM flow in accordance with one example;

FIG. 3 shows an RTMR-based vTPM software (SW) stack in accordance with one example;

FIG. 4 shows a vTPM SW stack based on a conventional vTPM solution;

FIGS. 5A and 5B are flow diagrams of an example process for implementing a vTPM;

FIG. 5C is a block diagram of an example platform for implementing a vTPM;

FIG. 6 is a block diagram of an electronic apparatus incorporating at least one electronic assembly and/or method described herein;

FIG. 7 illustrates a computing device in accordance with one implementation of the invention; and

FIG. 8 is included to show an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

Some solutions implement vTPM in/as (1) a service running on a separate platform or a separate VM, (2) the underlying virtual machine manager (VMM), (3) in case of SEV, the same SEV VM as the “client” but on a more privileged VMPL (VM Privilege Level), (4) a L1 VMM in the same trust domain (TD) as the “client”, while the “client” runs as a L2 VM (also referred to as a TD partition), or (5) a “Service TD” bound to the “client”.

Solutions (1) and (2) simply run the vTPM logic in regular (unprotected) context. They are generally considered non-solutions as their security depends on the CSP infrastructure, which is modeled “untrusted” by most security analyses on confidential computing. Certain CSPs today implement those as transitional solutions while looking for better ones that can exclude them from their customers' TCBs.

Solution (3) works on AMD SEV-SNP only. The vTPM in this case resides in the same SEV as the “client” platform but on a more privileged VMPL, which is similar to running the vTPM in “kernel mode” with the “client” in “user mode”. The “client” hence can access the vTPM through defined interface only (without the ability to alter the vTPM's code or data). If the SEV VM is compromised at the privileged VMPL then the vTPM will also be compromised and could be used to issue malicious attestation reports.

Solution (4) works on TDX (with partitioning support) only. The idea is identical to Solution (2) except the VMM in this case is a L1 VMM running in the same TD as the “client”, which runs as a L2 VM (called a TD partition).

As to solution (5), a “Service” TD is just a regular TD but can be “bound” to other TDs. Once bound, the Service TD's measurement will be included into the measurement of the TD it is bound to. Also, TDX-SEAM has dedicated several new TDCALL leaves to facilitate communication between a TD and its Service TDs. By hosting the vTPM in a Service TD, it simplifies the attestation process (i.e., the vTPM Service TD does not have to be attested separately) and the core root of trust for measurement (CRTM) (i.e., early boot code can access vTPM through TDCALLs instead of network stacks). However, it still carries the same problems in terms of cost (consuming a TD key and a vCPU), complexity (especially around live migration), and security as described above.

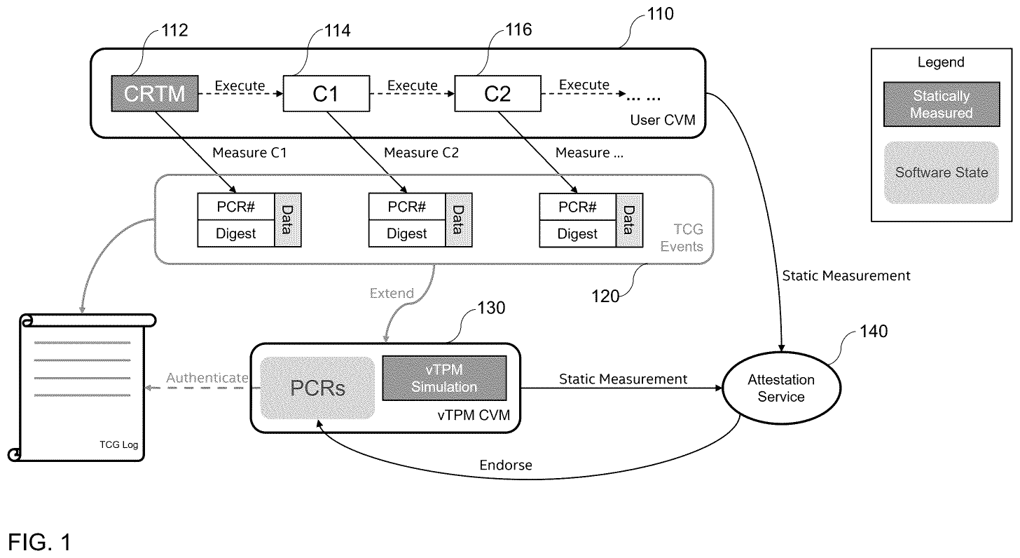

There are several vTPM solutions. At a high level, all existing solutions share the common approach depicted in FIG. 1. FIG. 1 shows an example vTPM flow. A vTPM is a software-based representation of a physical Trusted Platform Module (TPM) chip. A vTPM acts as any other virtual device. A vTPM provides hardware-based, security-related functions such as random number generation, attestation, key generation, etc. In FIG. 1, the vTPM code along with its internal state (e.g., platform configuration registers (PCRs)) is hosted in an isolated execution environment.

The user confidential VM (CVM) 110 boots from the Core Root of Trust for Measurement (CRTM) 112, which is part of the CVM's initial memory image (hence included in the CVM's static measurement) and is usually the virtual BIOS (vBIOS). The CRTM 112 then loads and measures the next software component (e.g., the OS loader), denoted as C1 114, before executing it. C1 follows the same pattern of measuring the next component C2 116 (e.g., the OS kernel) before passing control to it. The process continues until all security sensitive components (e.g., kernel mode drivers and their configuration, user password database, etc.) have been measured and loaded.

The measurements (cryptographic hashes) of the software components are recorded in the form of TCG events 120. Each TCG event at a high level includes a header and a data section. The data section contains information about the measured component, such as its type (e.g., executable vs. configuration) and the digest (cryptographic hash) of its content, while the header contains the digest of the data section along with a PCR index. On a physical platform with a physical TPM, a TPM2_PCR_Extend command is used to extend the PCR (selected by the PCR index) with the digest. This has been mirrored into all existing vTPM solutions as depicted in FIG. 1.

The user CVM 110 sends TCG events (in the form of the event data's digest) to the vTPM (in the form of a TPM2_PCR_Extend command), which interprets/simulates the command and updates its internal state accordingly. When attestation to the user CVM 110 is requested, the vTPM signs the PCR values using an (asymmetric) attestation key, which is usually certified by the Attestation Service 140 (usually provided by the CSP). The Attestation Service 140 establishes its trust in the vTPM by verifying its measurement extracted from a TEE-specific attestation report generated by the TEE hardware hosting the vTPM.

The drawbacks of the above approach can be summarized from two aspects: cost/complexity and security.

From the cost/complexity perspective: The vTPM itself is additional software that requires development, validation, and maintenance. Communication with the vTPM imposes additional code in the user CVM, and it must deal with potential security issues such as making sure it is talking to the same vTPM for the whole lifespan of the user CVM. When the user CVM is being live migrated to a different physical platform, the vTPM (or its internal state) must be migrated as well. Certain TEE technologies (e.g., TDX) can support only a limited number of CVMs per platform. The additional vTPM CVM effectively lowers the platform capacity (for running TEEs). Similarly, this can be viewed as a 2× cost adder if a User CVM must be backed by a second CVM implementing the vTPM.

TDX is the newest confidential computing technology. TDX is a hardware-based trusted execution environment (TEE) that facilitates the deployment of trust domains (TD), which are hardware-isolated VMs designed to protect sensitive data and applications from unauthorized access. A CPU-measured TDX module enables TDX. This software module (TDX module) runs in a new CPU Secure Arbitration Mode (SEAM) as a peer virtual machine manager (VMM) and supports TD entry and exit using the existing virtualization infrastructure. The TDX module is hosted in a reserved memory space identified by the SEAM Range Register (SEAMRR).

TDX uses hardware extensions for managing and encrypting memory and protects both the confidentiality and integrity of the TD CPU state from non-SEAM mode. TDX uses architectural elements such as SEAM, a shared bit in Guest Physical Address (GPA), secure Extended Page Table (EPT), physical-address-metadata table, Total Memory Encryption-Multi-Key, and remote attestation. TDX ensures data integrity, confidentiality, and authenticity, which empowers engineers and tech professionals to create and maintain secure systems, enhancing trust in virtualized environments.

At TD creation, the TDX module is designed to initialize the measurement registers for the TD. As part of the TD creation, the VMM would request the module to add a set of pages to the TD. The TDX module would then extend a static measurement register called TD-measurement register (TDMR) with the measurements of the initial pages added to the TD along with metadata associated with these pages. The TDX module also provides the TD a set of runtime-extendable measurement registers (RTMR) that would be extended by the code in the TD with measurements of additional code and data at runtime.

The RTMRs are housed in the TDX module. The RTMRs are protected within the core of TDX instead of storing those values inside a CVM protected by TDX. The latter (storing the values inside a CVM) can be compromised by a compromise of the VM whereas the former (storing the values in the RTMRs that are protected within the TDX) requires that the entirety of TDX be compromised.

From the security perspective: It is a single point of failure. A compromised vTPM may allow adversaries to change any PCR to any value (to authenticate a measurement log of arbitrary contents), and render whatever defenses built into the user CVM useless. It is an extra attack surface. Adversaries are offered more options to attack a user CVM, such as by attacking the vTPM attached to the user CVM. Some implementations may also allow a vTPM CVM to be shared by multiple user CVMs, in which case an adversary may use a malicious/compromised user CVM to affect/alter another user CVMs.

Examples disclosed herein provide a novel approach based on RunTime Measurement Registers (RTMRs) for implementing vTPMs. It is distinguished for the following reasons. Isolated execution environment is no longer required for the vTPM. This simplifies implementations and eliminates most problems that existing solutions must deal with. In addition, an RTMR provides better security. RTMRs are protected by hardware security features and are stored separately from the CVM. The TDX Module must be compromised in order to alter the RTMRs outside of the “extend” API which prevents arbitrary value assignment. PCR values are authenticated by hardware RTMRs and retain the same security properties as defined in the original TPM specs. This contrasts to existing vTPM solutions where PCR values are kept in memory variables that could potentially be changed to anything should the vTPM be compromised.

The example schemes disclosed herein keep the PCR values in an RTMR log. Instead of keeping the PCR values as variables in memory as in all conventional solutions, the example schemes disclosed herein keep the history of the measurement values that have been extended to PCRs in the form of RTMR log entries, which are authenticated by the corresponding RTMR and can be replayed later to calculate the actual PCR values.

The example schemes disclosed herein can not only provide the functionality of real PCRs but also retain their security properties, i.e., PCR log entries, once logged, can never be tampered (without being detected) regardless of what software is running on that platform (i.e., trust domain (TD)).

The example schemes disclosed herein are cheaper, simplify vTPM-based attestation, and improve its security at the same time. Given it relies on an RTMR, its technical benefits will strengthen CSPs' (and their customers') bond with TDX.

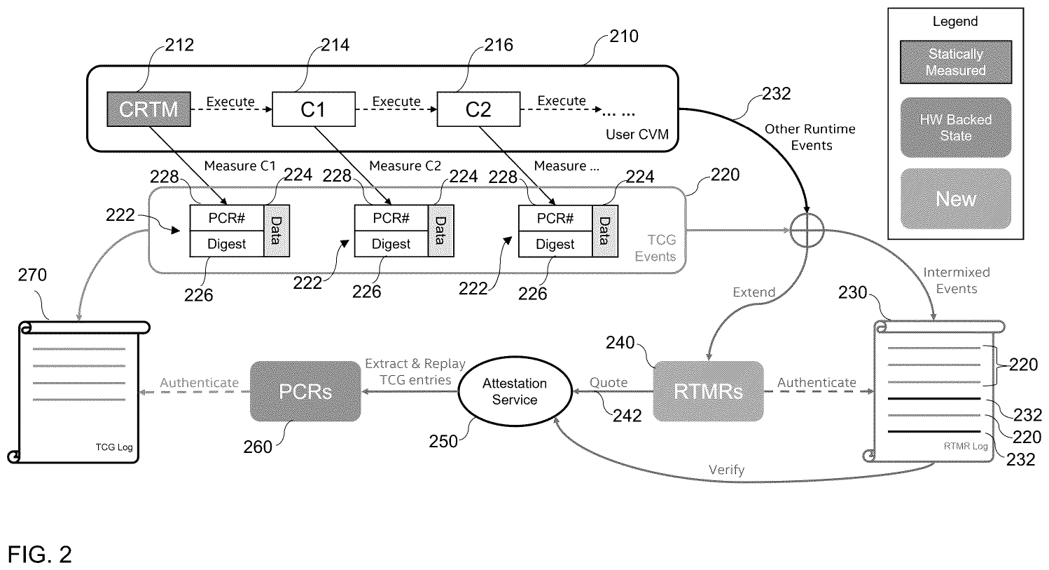

FIG. 2 shows an RTMR-based vTPM flow in accordance with one example. At the top of the diagram is an abstract boot flow. The user confidential VM (CVM) 210 boots from the Core Root of Trust for Measurement (CRTM) 212, which is part of the CVM's initial memory image (hence included in the CVM's static measurement) and is usually the virtual BIOS (vBIOS). The CRTM 212 then loads and measures the next software component (e.g., the OS loader), denoted as C1 214 in FIG. 2, before executing it. C1 follows the same pattern of measuring the next component C2 216 (e.g., the OS kernel) before passing control to it. The process continues until all security sensitive components (e.g., kernel mode drivers and their configuration, user password database, etc.) have been measured and loaded.

The measurements (e.g., cryptographic hashes) of the software components are recorded in the form of TCG events 220. Each TCG event at a high level includes a header 222 and a data section 224. The data section 224 contains information about the measured component, such as its type (e.g., executable vs. configuration) and a digest of its content, while the header 222 contains a digest 226 of the data section 224 along with a PCR index 228. On a physical platform with a physical TPM, a TPM2_PCR_Extend command was used to extend the PCR (selected by the PCR index) with the digest. The TPM2_PCR_Extend command extends a digest into a PCR.

In example schemes disclosed herein, the PCR index 228 and the digest 226 of each TCG event are logged into the RTMR log 230, and a digest of the RTMR log entry is extended into the RTMR 240. The RTMR 240 is a register configured/dedicated for the user CVM 210 for recording measurement for the components on the user CVM 210. A plurality of user CVMs may be set up on a platform simultaneously, and each user CVM 210 may be configured with a set of dedicated/isolated RTMRs. The measurement (i.e., a hash) is extended into the RTMR 240 of the CVM 210. To store a new value in the RTMR 240, the existing value is extended with the new value. The existing value is concatenated with the new value, and the resulting concatenation is used as input to the associated hashing algorithm, which computes a digest of the input. The computed digest becomes the new value of the RTMR 240. The RTMR value is included as part of the attestation quote. There may be other measurable events generated outside of the TCG flow described above, and those measurements 232 may be intermixed with the TCG events 220 in the RTMR log 230.

Attestation is used to verify the trustworthiness of the CVM 210 to other entities (e.g., a relying party). The attestation may be local attestation or remote attestation. During attestation, the CVM hardware (e.g., TDX ISA) attests to the RTMR values in the form of a quote 242 (i.e., signed attestation) (e.g., with the help of TD Quote Enclave (TDQE)). For example, the CVM hardware retrieves the RTMR values and sends them to the Quoting Enclave (QE) to generate the quote 242. The Quoting Enclave uses a platform unique asymmetric attestation key to digitally-sign the quote. The signed quote 242 can then be verified by another party using the corresponding public key or certificate. The measurements, which contain hashes of various TCG events, are recorded into the RTMR and are then signed into the quote 242. The system event logs (the RTMR log 230) are also sent together with the signed quote 242 to the verifier (e.g., an attestation service 250) for verification. The verifier can perform attestation verification against the quote 242 to determine whether the user CVM runs in a trusted environment. The attestation service 250 verifies the quote 242 using the quote signing certificate or public key, extracts from the quote 242 the value of the RTMR whose log contains the TCG events, and then verifies the RTMR log using the RTMR value. The quote 242 can be verified by any software entity with access to the quote signing public key/certificate. In FIG. 2, an attestation service 250 is used as an example.

In some examples, the attestation service 250 may optionally derive PCR values (i.e., vTPM quote) from the RTMR log entries for verification of the state of the user CVM 210 by a legacy/TCG remote relying party (RRP). To derive the PCR values, the attestation service 250 verifies the quote 242 using the quote signing certificate or public key, extracts from the quote 242 the value of the RTMR whose log contains the TCG events, then verifies the RTMR log using the RTMR value, and then extracts and replays the TCG log entries 220 to calculate the PCR values 260. The PCR values 260 can be used to verify the legacy/TCG event log 270 by a legacy/TCG RRP. In this scenario, the attestation service 250 effectively acts as a “vTPM” to attest to (sign) the PCR values. However, the attestation service 250 participates only in the attestation flow, while in conventional solutions the vTPM participates in both measurement and attestation flows so must run along with its “client” platform.

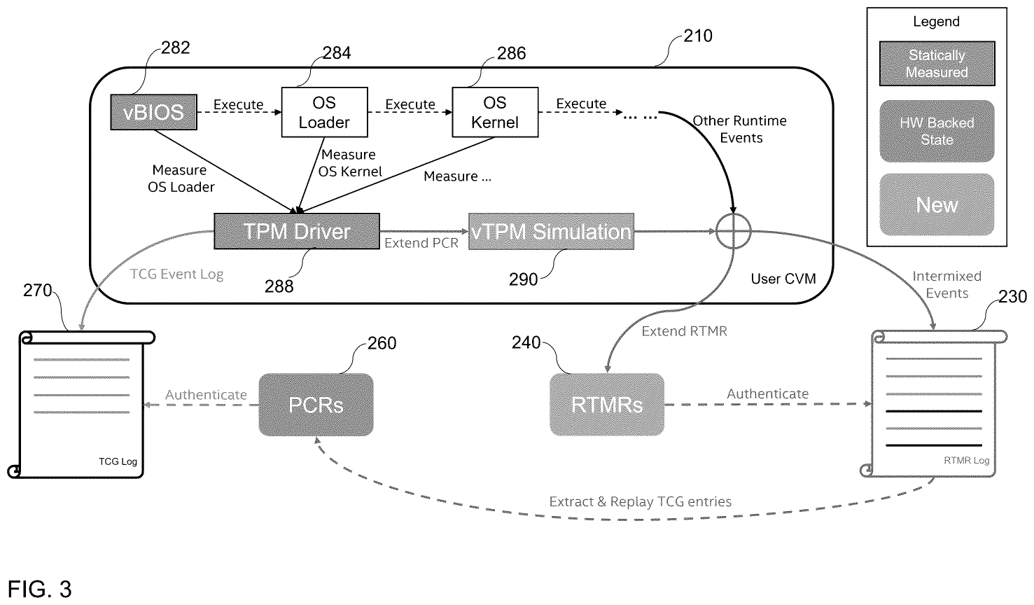

FIG. 3 shows an RTMR-based vTPM software stack in accordance with one example. FIG. 3 depicts the example scheme disclosed above with respect to FIG. 2 from a different angle. The user CVM 210 illustrates the boot flow along with vTPM related components hosted in it. The vBIOS 282 loads, measures, and executes the OS loader 284, which then loads, measures, and executes the OS kernel 286, and so on. The TPM driver 288 logs the TCG events (e.g., the measurements of the OS loader 284, the OS kernel 286, and subsequent software components) in the TCG event log 270 and extends the measurements (TCG events) to the PCR. The vTPM simulation 290 logs the PCR index and the digest into the RTMR log 230 and extends a digest of the RTMR log entry into the RTMR 240. The vBIOS 282, the TPM driver 288, and the vTPM simulation 290 collectively comprise the CRTM 212 shown in FIG. 2.

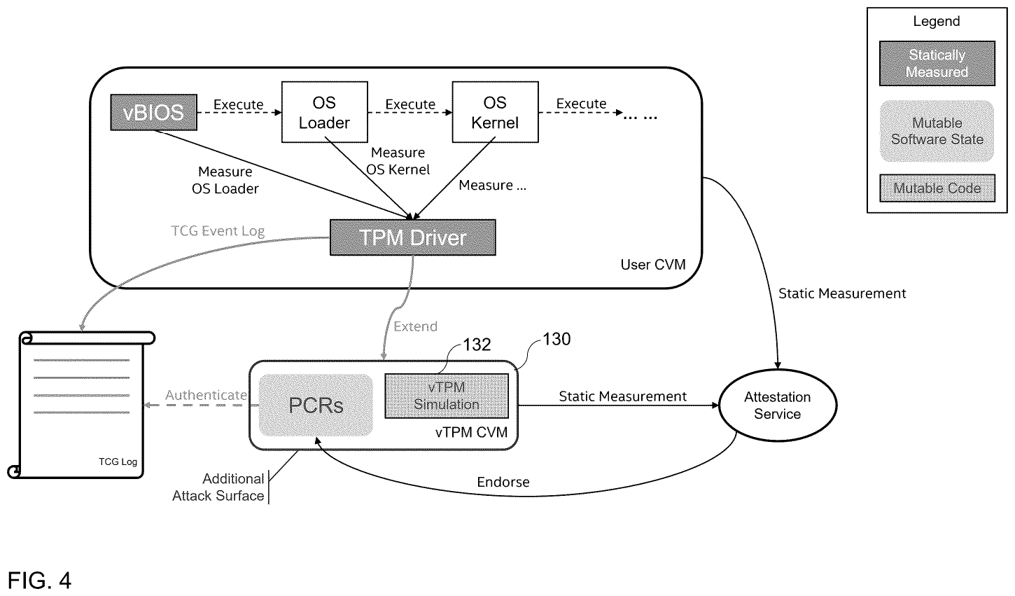

FIG. 4 shows a vTPM software stack for implementing vTPM. As a comparison, FIG. 4 depicts the same boot flow and components as in FIG. 3 but based on a conventional vTPM solution. The most significant/important difference is the placement of the vTPM simulation component. Conventionally, the vTPM simulation component 132 must reside in a separate CVM 130 as depicted in FIG. 4. In contrast, in accordance with the examples disclosed herein, the vTPM simulation component 290 is inside the user CVM 210 as shown in FIG. 3. The reason for the difference is where/how PCR values are stored/protected. All existing solutions keep PCR values in memory, hence must protect them along with the code that manipulates them in an execution environment isolated from the user CVM. In contrast, in examples disclosed herein, the history of values extended to PCRs is stored in the RTMR logs 230, and the security properties of RTMRs guarantee that the history (which is recorded in the RTMR logs 230) can never be tampered without being detected. RTMRs are protected by hardware security features and are stored separately from the CVM in the TDX Module. The TDX Module must be compromised in order to alter the RTMRs outside of the “extend” API which prevents arbitrary value assignment. It is true even if the vTPM simulation component 290 is compromised later by an adversary in the user CVM 210. Such a compromised vTPM simulation component can only extend the existing measurement chain, it cannot alter previous measurements because it cannot directly write values to the RTMRs. Hence, this invention eliminates the requirement of hosting the vTPM in a separate TEE, along with all the associated problems and costs.

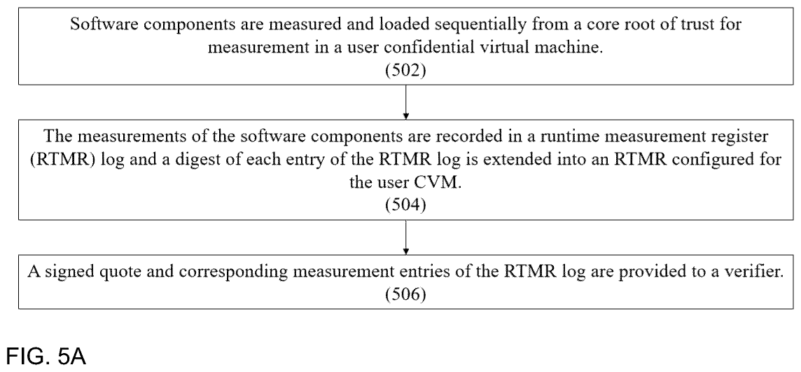

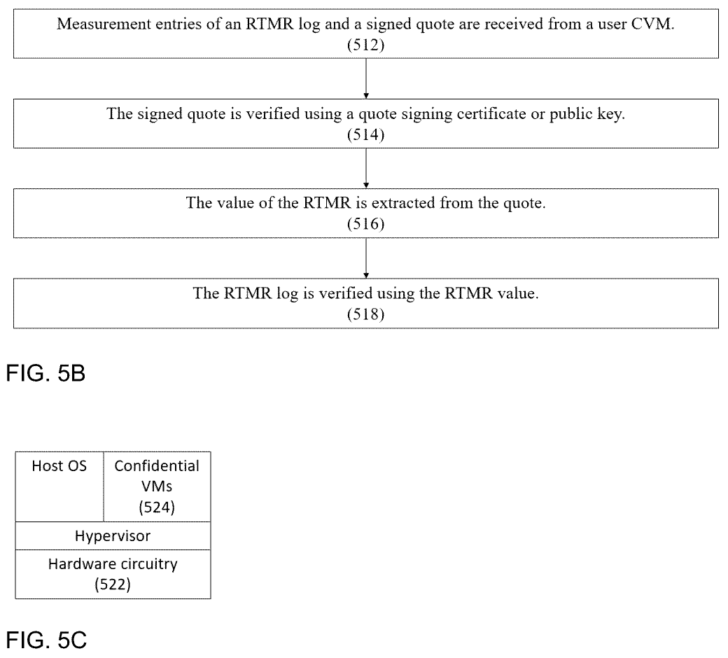

FIG. 5A is a flow diagram of an example process for implementing a virtual trust platform module (vTPM). The method includes measuring and loading software components sequentially from a CRTM in a user CVM (502). Each software component is measured before being loaded. The user CVM is a virtual machine executed inside a trusted execution environment. The user CVM may be a hardware-isolated virtual machine deployed in a TDX-enabled execution environment.

The measurements of the software components are recorded in a runtime measurement register (RTMR) log and a digest of each entry of the RTMR log is extended into an RTMR configured for the user CVM (504). A signed quote and corresponding measurement entries of the RTMR log are provided to a verifier (506). The signed quote includes a value of the RTMR. The measurements of the software components may be recorded in the RTMR log in a form of TCG event.

A state of the user CVM may be verified based on the signed quote and the RTMR log. The signed quote may be verified using a quote signing certificate or public key. The value of the RTMR may be extracted from the quote, and the RTMR log may be verified using the RTMR value. The measurements of the software components may also be recorded in a TCG event log. The measurement entries of the RTMR log may be extracted and replayed to calculate PCR values, and the TCG event log may be verified using the PCR values.

FIG. 5B is a flow diagram of an example process for implementing a vTPM. The method may include receiving measurement entries of an RTMR log and a signed quote from a user CVM (512). The user CVM may be a hardware-isolated virtual machine deployed in a TDX-enabled execution environment. The RTMR log includes measurements of software components that are sequentially loaded in the user CVM, and the signed quote includes a value of an RTMR configured for the user CVM. The RTMR includes a digest of each entry of the RTMR log. The signed quote is verified using a quote signing certificate or public key (514). The value of the RTMR is extracted from the quote (516). The RTMR log is verified using the RTMR value (518).

The measurements of the software components may be recorded in a TCG event log. The entries of the RTMR log may be extracted and replayed to calculate PCR values, and the TCG event log may be verified using the PCR values. The measurements of the software components are recorded in the RTMR log in a form of TCG event.

FIG. 5C is a block diagram of an example platform for implementing a vTPM. The platform includes hardware circuitry (522). A hypervisor runs on the hardware circuitry (522), and a host OS and a plurality of CVMs may run on the hypervisor. The circuitry (522) is configured to set up a plurality of CVMs (524). Multiple instances of OS and CVMs may run on the same physical computing resources. The user CVMs are a virtual machine executed in a trusted execution environment. The user CVM may be a hardware-isolated virtual machine deployed in a TDX-enabled execution environment. The circuitry (522) is configured to boot a user CVM from a CRTM and measure and load software components sequentially therefrom. Each software component is measured before being loaded. The circuitry (522) is configured to initialize a RTMR for the user CVM and record measurements of the software components in an RTMR log and extend a digest of each entry of the RTMR log into an RTMR configured for the user CVM. The circuitry 522 may be configured to provide a signed quote and corresponding TCG entries of the RTMR log to a verifier. The signed quote includes a value of the RTMR. The measurements of the software components may be recorded in the RTMR log in a form of TCG event. The circuitry 522 may be configured to verify the signed quote using a quote signing certificate or public key, extract from the quote the value of the RTMR, and verify the RTMR log using the RTMR value. The measurements of the software components may also be recorded in a TCG event log. The circuitry 522 may be configured to extract and replay the measurement entries of the RTMR log to calculate PCR values and verify the TCG event log using the PCR values.

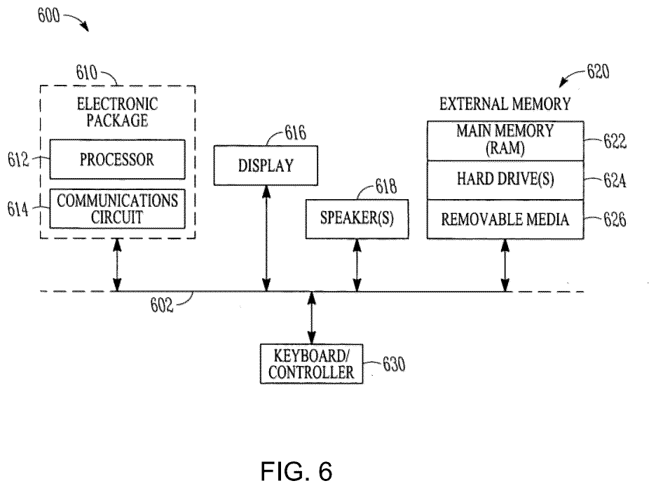

FIG. 6 is a block diagram of an electronic apparatus 600 incorporating at least one electronic assembly and/or method described herein. Electronic apparatus 600 is-merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

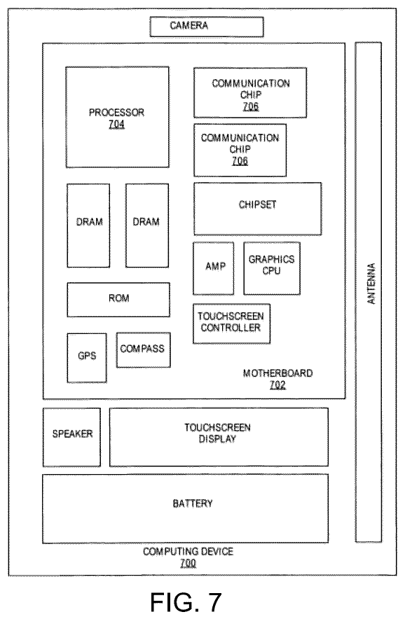

FIG. 7 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or cWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

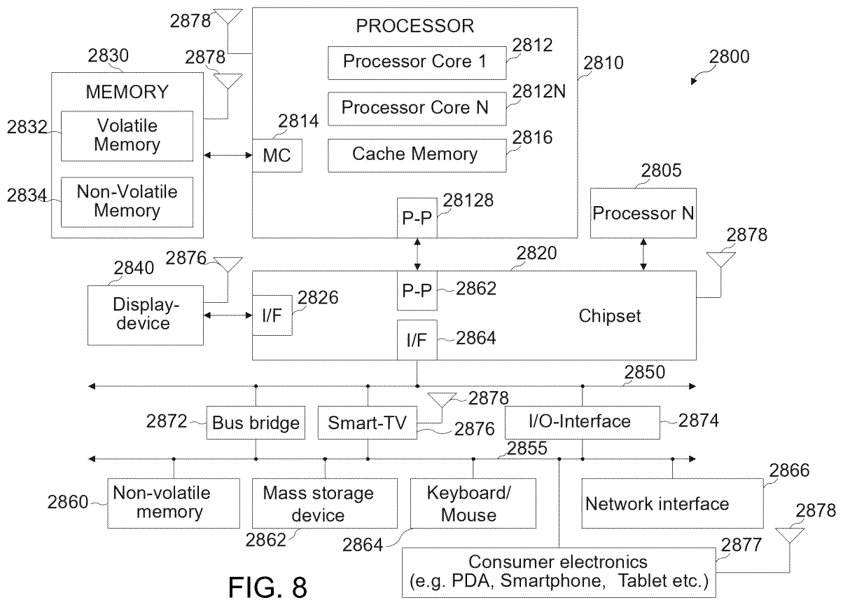

FIG. 8 is included to show an example of a higher level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 28 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a method for implementing a vTPM. The method includes measuring and loading software components sequentially from a CRTM in a user CVM, wherein each software component is measured before being loaded, and the user CVM is a virtual machine executed inside a trusted execution environment; recording measurements of the software components in a RTMR log and extending a digest of each entry of the RTMR log into an RTMR configured for the user CVM; and providing a signed quote and corresponding measurement entries of the RTMR log to a verifier, wherein the signed quote includes a value of the RTMR.

Another example, (e.g., example 2) relates to a previously described example (e.g., example 1), wherein the measurements of the software components are recorded in the RTMR log in a form of TCG event.

Another example, (e.g., example 3) relates to a previously described example (e.g., example 2), further comprises verifying the signed quote using a quote signing certificate or public key, extracting from the quote the value of the RTMR, and verifying the RTMR log using the RTMR value.

Another example, (e.g., example 4) relates to a previously described example (e.g., example 3), wherein the measurements of the software components are recorded in a TCG event log.

Another example, (e.g., example 5) relates to a previously described example (e.g., example 4), further comprises extracting and replaying the measurement entries of the RTMR log to calculate PCR values and verifying the TCG event log using the PCR values.

Another example, (e.g., example 6) relates to a previously described example (e.g., any one of examples 1-5), wherein the user CVM is a hardware-isolated virtual machine deployed in a TDX-enabled execution environment.

Another example, (e.g., example 7) relates to a method for implementing a vTPM. The method includes receiving measurement entries of a RTMR log and a signed quote from a user CVM, wherein the RTMR log includes measurements of software components that are sequentially loaded in the user CVM, and the signed quote includes a value of an RTMR configured for the user CVM, wherein the RTMR includes a digest of each entry of the RTMR log; verifying the signed quote using a quote signing certificate or public key; extracting from the quote the value of the RTMR; and verifying the RTMR log using the RTMR value.

Another example, (e.g., example 8) relates to a previously described example (e.g., example 7), wherein the measurements of the software components are recorded in a TCG event log, and the method further comprises extracting and replaying the entries of the RTMR log to calculate PCR values and verifying the TCG event log using the PCR values.

Another example, (e.g., example 9) relates to a previously described example (e.g., any one of examples 7-8), wherein the measurements of the software components are recorded in the RTMR log in a form of TCG event.

Another example, (e.g., example 10) relates to a previously described example (e.g., any one of examples 7-9), wherein the user CVM is a hardware-isolated virtual machine deployed in a TDX-enabled execution environment.

Another example, (e.g., example 11) relates to a compute platform, comprising circuitry configured to set up a user CVM, wherein the circuitry is configured to boot the user CVM from a CRTM and measure and load software components sequentially, wherein each software component is measured before being loaded, and the user CVM is a virtual machine executed inside a trusted execution environment. The circuitry is configured to initialize a RTMR for the user CVM and record measurements of the software components in an RTMR log and extend a digest of each entry of the RTMR log into an RTMR configured for the user CVM and provide a signed quote and corresponding TCG entries of the RTMR log to a verifier, wherein the signed quote includes a value of the RTMR.

Another example, (e.g., example 12) relates to a previously described example (e.g., example 11), wherein the measurements of the software components are recorded in the RTMR log in a form of TCG event.

Another example, (e.g., example 13) relates to a previously described example (e.g., example 12), wherein the circuitry is configured to verify the signed quote using a quote signing certificate or public key, extract from the quote the value of the RTMR, and verify the RTMR log using the RTMR value.

Another example, (e.g., example 14) relates to a previously described example (e.g., example 13), wherein the measurements of the software components are recorded in a TCG event log.

Another example, (e.g., example 15) relates to a previously described example (e.g., example 14), wherein the circuitry is configured to extract and replay the measurement entries of the RTMR log to calculate PCR values and verify the TCG event log using the PCR values.

Another example, (e.g., example 16) relates to a previously described example (e.g., any one of examples 11-15), wherein the user CVM is a hardware-isolated virtual machine deployed in a TDX-enabled execution environment.

Another example, (e.g., example 17) relates to a machine-readable storage including machine readable instructions, when executed, to implement the method as in any one of example 1-6.

Another example, (e.g., example 18) relates to a machine-readable storage including machine readable instructions, when executed, to implement the method as in any one of examples 7-10.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F) PLAs) or (field) programmable gate arrays ((F) PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for implementing a virtual trust platform module (vTPM), comprising:
measuring and loading software components sequentially from a core root of trust for measurement (CRTM) in a user confidential virtual machine (CVM), wherein each software component is measured before being loaded, and the user CVM is a virtual machine executed inside a trusted execution environment;
recording measurements of the software components in a runtime measurement register (RTMR) log and extending a digest of each entry of the RTMR log into an RTMR configured for the user CVM; and
providing a signed quote and corresponding measurement entries of the RTMR log to a verifier, wherein the signed quote includes a value of the RTMR.

2. The method of claim 1, wherein the measurements of the software components are recorded in the RTMR log in a form of Trusted Computing Group (TCG) event.

3. The method of claim 2 further comprising:
verifying the signed quote using a quote signing certificate or public key;
extracting from the quote the value of the RTMR; and
verifying the RTMR log using the RTMR value.

4. The method of claim 3, wherein the measurements of the software components are recorded in a TCG event log.

5. The method of claim 4 further comprising:
extracting and replaying the measurement entries of the RTMR log to calculate platform configuration register (PCR) values; and
verifying the TCG event log using the PCR values.

6. The method of claim 1, wherein the user CVM is a hardware-isolated virtual machine deployed in a Trust Domain Extension (TDX)-enabled execution environment.

7. A method for implementing a virtual trust platform module (vTPM), comprising:
receiving measurement entries of a runtime measurement register (RTMR) log and a signed quote from a user confidential virtual machine (CVM), wherein the RTMR log includes measurements of software components that are sequentially loaded in the user CVM, and the signed quote includes a value of an RTMR configured for the user CVM, wherein the RTMR includes a digest of each entry of the RTMR log;
verifying the signed quote using a quote signing certificate or public key;
extracting from the quote the value of the RTMR; and
verifying the RTMR log using the RTMR value.

8. The method of claim 7, wherein the measurements of the software components are recorded in a Trusted Computing Group (TCG) event log, and the method further comprising:
extracting and replaying the entries of the RTMR log to calculate platform configuration register (PCR) values; and
verifying the TCG event log using the PCR values.

9. The method of claim 7, wherein the measurements of the software components are recorded in the RTMR log in a form of TCG event.

10. The method of claim 7, wherein the user CVM is a hardware-isolated virtual machine deployed in a Trust Domain Extension (TDX)-enabled execution environment.

11. A compute platform, comprising:
circuitry configured to set up a user confidential virtual machine (CVM), wherein the circuitry is configured to boot the user CVM from a core root of trust for measurement (CRTM) and measure and load software components sequentially, wherein each software component is measured before being loaded, and the user CVM is a virtual machine executed inside a trusted execution environment,
wherein the circuitry is configured to initialize a runtime measurement register (RTMR) for the user CVM and record measurements of the software components in an RTMR log and extend a digest of each entry of the RTMR log into an RTMR configured for the user CVM and provide a signed quote and corresponding Trusted Computing Group (TCG) entries of the RTMR log to a verifier, wherein the signed quote includes a value of the RTMR.

12. The compute platform of claim 11, wherein the measurements of the software components are recorded in the RTMR log in a form of Trusted Computing Group (TCG) event.

13. The compute platform of claim 12 wherein the circuitry is configured to verify the signed quote using a quote signing certificate or public key, extract from the quote the value of the RTMR, and verify the RTMR log using the RTMR value.

14. The compute platform of claim 13, wherein the measurements of the software components are recorded in a TCG event log.

15. The compute platform of claim 14 wherein the circuitry is configured to extract and replay the measurement entries of the RTMR log to calculate platform configuration register (PCR) values and verify the TCG event log using the PCR values.

16. The compute platform of claim 11, wherein the user CVM is a hardware-isolated virtual machine deployed in a Trust Domain Extension (TDX)-enabled execution environment.

17. A machine-readable storage including machine readable instructions, when executed, to implement the method of claim 1.

18. A machine-readable storage including machine readable instructions, when executed, to implement the method of claim 7.
